(19) United States
(12) Patent Application Publication
(10) Pub. No.: US 2025/0170915 A1
(43) Pub. Date: May 29, 2025

(54) CHARGING SYSTEM AND CHARGING VEHICLE

(71) Applicant: ISUZU MOTORS LIMITED, Yokohama-shi, Kanagawa (JP)

(72) Inventor: Yukiji OKURA, Fujisawa-shi, Kanagawa (JP)

(21) Appl. No.: 18/725,169

(22) PCT Filed: Dec. 19, 2022
(86) PCT No.: PCT/JP2022/046692

§ 371 Date: Jun. 28, 2024

(30) Foreign Application Priority Data
Jan. 5, 2022 (JP) 2022-000560

(51) Int. Cl. B60L 53/57; B60L 53/53

(52) U.S. Cl. CPC B60L 53/57; B60L 53/53; B60L 2210/30

(57) ABSTRACT

This charging system can achieve faster charging. The charging system comprises a first power conversion unit that converts AC power supplied from an AC power source into DC power and has a rated output of 50 kW or less, and a second power conversion unit that has a feature of supplying the DC power output from the first power conversion unit to a battery and a feature of generating DC power exceeding 50 kW by using the DC power output from the battery and supplying the generated DC power to an electric vehicle via a contactor.

### TECHNICAL FIELD

The present disclosure relates to a charging system and a charging vehicle.

### BACKGROUND ART

Patent Literature (hereinafter referred to as “PTL”) 1 discloses a vehicle for charging (hereinafter referred to as “charging vehicle”) that supplies power to an electrically powered vehicle such as an Electric Vehicle (EV) bus and EV truck equipped with a storage battery for traveling. The charging vehicle of PTL 1 includes: a secondary battery for charging the storage battery for traveling mounted on a vehicle to be charged; a generator that has a rated power less than 50 kW and supplies Alternating current (AC) power; and an Alternating Current-to-Direct Curret (AC/DC) converter that converts the AC power into Direct current (DC) power and thus charges the secondary battery.

### CITATION LIST

### Patent Literature

### PTL 1

Japanese Patent Application Laid-Open No. 2013-009534

### SUMMARY OF INVENTION

### Technical Problem

In recent years, reflecting the needs for rapid (quick) charging of an electric vehicle, rapid chargers conforming to the CHAdeMO system (registered trademark) with a rated output of 50 kW have been widely spread. In order to achieve further rapid charging, a special charger with a rated output exceeding 50 kW is required. Introduction of such a special charger, however, may require, for example, appointment of an electric works specialist and notification of safety regulations. Hence, there is room for improvement in responding to the needs for further shortening of the charging time.

An object of the present disclosure is to provide a charging system and a charging vehicle each capable of achieving further rapid charging.

### Solution to Problem

An charging system according to an aspect of the present disclosure includes: a first power conversion section that has a rated output of 50 kW or less and that converts Alternating current (AC) supplied from an AC power source into Direct current (DC); and; and a second power conversion section that includes a function to supply a storage battery with DC output from the first power conversion section and a function to generate DC power exceeding 50 kW, by using the DC output from the storage battery, and to supply an electric vehicle with the generated DC power through a contactor.

A charging vehicle according to an aspect of the present disclosure includes the charging system described above.

### Advantageous Effects of Invention

According to the present disclosure, further rapid charging can be achieved.

### BRIEF DESCRIPTION OF DRAWINGS

FIG. 1 illustrates an exemplary configuration of a charging vehicle in an embodiment of the present disclosure; and

FIG. 2 illustrates the charging vehicle according to the embodiment of the present disclosure and an electric vehicle parked next to the charging vehicle;

### DESCRIPTION OF EMBODIMENTS

Hereinafter, an embodiment of the present disclosure will be described with reference to the accompanying drawings. Note that, in all the drawings, an element the same as a precedent element is given the same reference numeral, and the description thereof may be omitted.

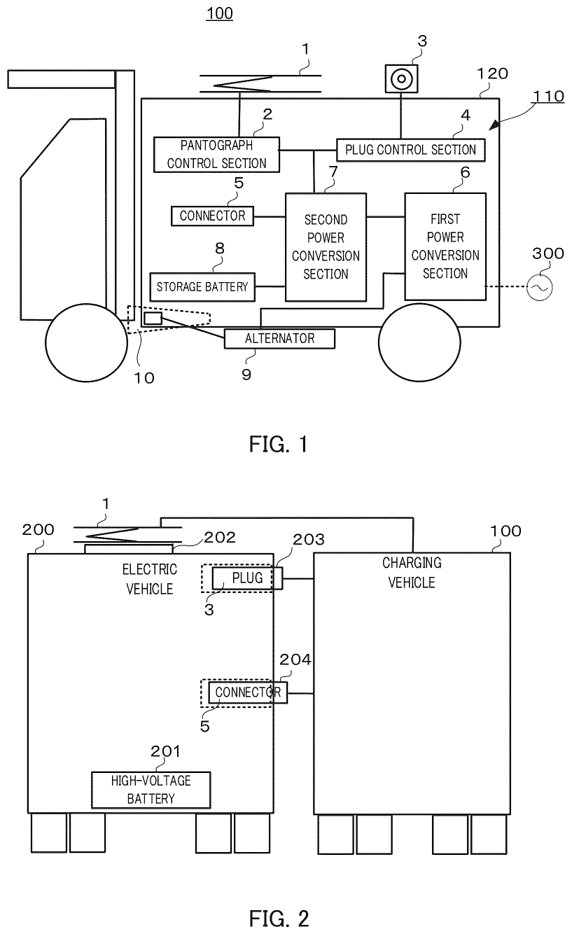

FIG. 1 illustrates an exemplary configuration of charging vehicle 100 according to an embodiment of the present disclosure, and FIG. 2 illustrates a state where electric vehicle 200 is fed by charging vehicle 100.

Charging vehicle 100 is a truck, a bus, or the like equipped with charging system 110 that rapidly charges high-voltage battery 201 mounted on electric vehicle 200. Details of a configuration of charging system 110 will be described later. Incidentally, charging vehicle 100 may be a van, a wagon, or a passenger vehicle, in addition to a truck or a bus, as long as it can be equipped with charging system 110.

Electric vehicle 200 is a truck, a bus, or the like equipped with at least a traction motor for traveling and high-voltage battery 201 for driving the traction motor.

Incidentally, electric vehicle 200 may be a van, a wagon, or a passenger vehicle, in addition to a truck or a bus, as long as it can be equipped with high-voltage battery 201.

### (Charging System 110)

Charging system 110 includes pantograph 1, pantograph control section 2, plug 3, plug control section 4, connector 5, first power conversion section 6, second power conversion section 7, storage battery 8, and alternator (AC generator) 9.

### (Pantograph 1 and Pantograph Control Section 2)

Pantograph 1 is an example of a contactor that feeds DC power to electric vehicle 200 by the contactor being brought into contact with conductive power collection section 202 installed on a cargo compartment of electric vehicle 200. Pantograph 1 is configured to have, for example, a plurality of links, a plurality of connecting shafts for connecting between the plurality of links such that, even when a relative position of power collection section 202 of electric vehicle 200 changes, power feeding can be performed following the position of power collection section 202. Power collection section 202 is installed at a place where difficult for persons to reach, e.g., on a ceiling of the cargo compartment.

A rated output of pantograph 1 is, for example, 480 kW, and a rated voltage of pantograph 1 is, for example, DC750 V. Pantograph 1 is driven by pantograph control section 2. Pantograph control section 2 moves pantograph 1 from cargo compartment 120 of charging vehicle 100 to power collection section 202 of electric vehicle 200, or moves pantograph 1 from power collection section 202 of electric vehicle 200 to cargo compartment 120 of charging vehicle 100.

Specifically, when an operation to move pantograph 1 toward electric vehicle 200 during stop is executed, pantograph control section 2 drives an actuator (not illustrated) and thus moves pantograph 1 from cargo compartment 120 of charging vehicle 100 to power collection section 202 of electric vehicle 200. This brings pantograph 1 into contact with power collection section 202, thereby enabling charging from charging vehicle 100 to electric vehicle 200.

When an operation to house pantograph 1 is executed after completion of the charging of electric vehicle 200, pantograph control section 2 drives the actuator (not illustrated) and thus moves pantograph 1 from power collection section 202 of electric vehicle 200 to cargo compartment 120 of charging vehicle 100. As a result, pantograph 1 separates from power collection section 202 and moves to cargo compartment 120 of charging vehicle 100, thereby allowing charging vehicle 100 to travel.

### (Plug 3 and Plug Control Section 4)

Plug 3 is an example of a contactor that feeds DC power to electric vehicle 200 by the contactor being brought into contact with charging port 203 (jack) installed in electric vehicle 200. Plug 3 is housed in cargo compartment 120 of electric vehicle 200 in a manner that allows forward and backward movement in a horizontal direction.

A rated output of plug 3 is, for example, 480 kW, and a rated voltage of plug 3 is, for example DC750 V. Plug 3 is driven by plug control section 4. Plug control section 4 moves plug 3 forward from charging vehicle 100 to charging port 203 of electric vehicle 200, or moves plug 3 backward from charging port 203 of electric vehicle 200.

Specifically, when an operation to insert plug 3 into charging port 203 installed in electric vehicle 200 during stop is executed, plug control section 4 drives an actuator (not illustrated) and thus moves plug 3 forward from charging vehicle 100 to charging port 203 of electric vehicle 200. As a result, plug 3 is inserted into charging port 203, enabling charging of electric vehicle 200.

When an operation to house plug 3 is executed after completion of the charging of electric vehicle 200, plug control section 4 drives the actuator (not illustrated) and thus moves plug 3 backward from charging port 203 of electric vehicle 200 to charging vehicle 100. As a result, plug 3 separates from power charging port 203 and is housed in charging vehicle 100, thereby allowing charging vehicle 100 to travel. In addition, this makes it possible to prevent plug 3 from being wet with rain and dirty with dust.

### (Connector 5)

Connector 5 is, for example, a male connector conforming to the Chaoji standard and is an example of a contactor that feeds DC power to electric vehicle 200 by the contactor being brought into contact with charging port 204 installed in electric vehicle 200. Connector 5 is connected to charging port 204 of electric vehicle 200 by using a robotic arm or the like, for example. This enables charging of electric vehicle 200. A rated output of connector 5 is, for example, 240 kW, and a rated voltage of connector 5 is, for example, DC750 V.

### (First Power Conversion Section 6)

First power conversion section 6 is an AC/DC converter that converts AC power supplied from system power supply 300 or alternator 9 into DC power of up to 50 kW and outputs the resultant power to second power conversion section 7. System power supply 300 and alternator 9 are examples of an AC power source according to an embodiment of the present disclosure. System power supply 300 is, for example, a commercial power source for supplying an AC voltage of 220 V. Alternator 9 is, for example, a rotating electric machine that generates an AC voltage of 220 V by utilizing a rotational force of transmission 10.

As first power conversion section 6, a charger conforming to the CHAdeMO specifications with a rated output of 50 kW_(400V/125 A) is used, for example. Note that first power conversion section 6 is not limited to this charger and may be a charger with a rated output of 50 kW or less, or, for example, a charger other than the charger conforming to the CHAdeMO specifications may be used.

Incidentally, an electric power contract exceeding 50 kW requires notification of appointment of an electric works specialist and safety regulations since such contract is considered involving supply of high-voltage power. On the other hand, an electric power contract with a low voltage does not require the appointment of an electric works specialist nor the notification of safety regulations, as long as a capacity of a charger is 50 kW or less. For this reason, an initial cost of introducing first power conversion section 6 to charging system 110 is only the purchasing cost of a charger, the installing cost of the charger, and the wiring-work cost.

In addition, since chargers conforming to the CHAdeMO specifications are widely used in Japanese domestic charging infrastructures, they are highly reliable and procurable inexpensively. In particular, since chargers conforming to the CHAdeMO specifications with a rated output of 50 kW have a stable quality because they are manufactured in a larger number than chargers conforming to the CHAdeMO specifications with a rated output exceeding 50 kW, and mass purchasing thereof makes it possible to reduce the procurement cost. In addition, the chargers conforming to the CHAdeMO specifications with a rated output of 50 kW are composed of general-purpose components, thus making it easier to repair in case of failure. Furthermore, as compared to a case where a charger conforming to the CHAdeMO specifications with a rated output of less than 50 kW (e.g., 20 kw), the charging time for storage battery 8 can be shortened.

Therefore, using a charger conforming to the CHAdeMO specifications with a rated output of 50 kW as first power conversion section 6 enables construction of highly reliable charging system 110 inexpensively and early without a cumbersome procedure such as notification of appointment of an electric works specialist. Hence, it is preferable to use, as first power conversion section 6, a charger conforming to the CHAdeMO specifications with a rated output of 50 kW_.

### (Second Power Conversion Section 7)

Second power conversion section 7 includes, for example, a switching circuit, a control circuit that controls driving of the switching circuit, a High Voltage Junction Box (HVJB), and the like. Second power conversion section 7 is a Direct Current to Direct Current (DC/DC) converter that includes a first function to boost DC output from first power conversion section 6 and supplies storage battery 8 with the resultant DC and a second function to generate DC power exceeding 50 kW by using DC output from storage battery 8 and supplies electric vehicle 200 with the resultant DC through a contactor.

Specifically, when charging storage battery 8 mounted on charging vehicle 100, second power conversion section 7 boosts a DC voltage output from first power conversion section 6 from 400 V to 750 V, for example, and thus supplies storage battery 8 with the resultant DC voltage. Second power conversion section 7 controls charging current while monitoring a temperature of storage battery 8, and terminates the charging when a State Of Charge (SOC) of storage battery 8 reaches a set value or 100%.

Further, when charging high-voltage battery 201 mounted on charging electric vehicle 200, second power conversion section 7 generates, by using the DC output from storage battery 8, power corresponding to the specifications of high-voltage battery 201, such as power of 480 kW (750V/640 A), 240 kW (750V/320 A), 256 kW (400V/640 A), or 128 kW(400V/320 A), and thus supplies electric vehicle 200 with the resultant power through pantograph 1, plug 3, or connector 5.

Incidentally, in addition to the above-described functions, second power conversion section 7 may be configured to generate power of DC24 V by using the DC output from storage battery 8 and thus outputs the generated power, in order to supply power to in-vehicle equipment of charging vehicle 100 (e.g., electrical component, refrigeration cycling apparatus).

### (Storage Battery 8)

Storage battery 8 is a large-capacity battery that can provide power commensurate with a capacity of high-voltage battery 201 mounted on electric vehicle 200. A capacity of storage battery 8 is 240 kWh, for example.

### (Charging Operation to Storage Battery 8)

When charging system 110 configured in this manner performs charging of storage battery 8, AC of system power supply 300 is converted into DC by first power conversion section 6, and the DC is boosted by second power conversion section 7 and thus supplied to storage battery 8, for example. Then, the charging of storage battery 8 is terminated when the SOC of storage battery 8 reaches a predetermined value.

### (Charging Operation to High-Voltage Battery 201)

For example, when charging of high-voltage battery 201 is performed by using pantograph 1, upon execution of a charging-start operation with pantograph 1 in contact with power collection section 202 of electric vehicle 200, DC power is supplied from storage battery 8 to high-voltage battery 201. At this time, second power conversion section 7 supplies electric vehicle 200 with DC power (e.g., 480 kW) exceeding a rated output of first power conversion section 6. In this manner described above, a super rapid charging of electric vehicle 200 can be performed.

As described above, charging system 110 according to an embodiment of the present disclosure includes: first power conversion section 6 that has a rated output of 50 kW or less and that converts AC supplied from an AC power source into DC; and second power conversion section 7 that includes a function to supply storage battery 8 with DC output from first power conversion section 6 and a function to generate DC power exceeding 50 kW, by using DC output from storage battery 8, and to supply electric vehicle 200 with the generated DC power through a contactor.

This configuration allows construction of charging system 110 that is inexpensive and is capable of a super rapid charging without a cumbersome procedure such as a notification of appointment of an electric works specialist.

Further, according to charging vehicle 100 equipped with this charging system 110, charging system 110 can be moved to electric vehicle 200 during stop, thereby allowing, when a plurality of electric vehicles 200 is parked in a site of a plant, for example, each electric vehicle 200 to be charged while being stopped. In particular, even when parking locations of a plurality of electric vehicles 200 are widely distributed, it is possible to greatly reduce a burden on the driver to move each electric vehicle 200. Additionally, it is also feasible to save labor of moving electric vehicle 200 for which feeding is completed to a predetermined parking location again.

Furthermore, when a further super-rapid charging is achieved by upgrading a function of charging system 110, it is only required to retrofit first power conversion section 6 and second power conversion section 7, which are mounted on electric vehicle 200, and wires connected to these sections. This eliminates the need for work such as repairing a base and retrofitting buried pipes, as compared to a case of retrofitting a ground-installed charger, thus enabling construction of a system of the further super-rapid charging system in a short period and at low cost.

Note that charging vehicle 100 can be used as a mobile emergency power source. Further, DC power supplied from charging vehicle 100 can be converted into AC power by connecting connector 5 to an inverter (not illustrated), thereby making it possible to operate a device driven by AC power (e.g., illumination equipment, heater).

For example, the following aspects are also understood to fall within the scope of the present disclosure.
1. A charging system according to the present disclosure includes: a first power conversion section that has a rated output of 50 kW or less and that converts AC supplied from an AC power source into DC; and a second power conversion section that includes a function to supply a storage battery with DC output from the first power conversion section and a function to generate DC power exceeding 50 kW, by using the DC output from the storage battery, and to supply an electric vehicle with the generated DC power through a contactor.
2. The first power conversion section is a charger having a rated output of 50 kW.
3. The first power conversion section is a charger conforming to a CHAdeMO system.
4. A charging vehicle of the present disclosure is equipped with the above-described charging system.

The present application is based on a Japanese Patent Application (Japanese Patent Application No. 2022-000560), filed on Jan. 5, 2022, the content of which is incorporated herein by reference.

### INDUSTRIAL APPLICABILITY

A charging system and a charging vehicle of the present disclosure are each useful for techniques that enable further rapid charging.

### REFERENCE SIGNS LIST

1 Pantograph
2 Pantograph control section
3 Plug
4 Plug control section
5 Connector
6 First power conversion section
7 Second power conversion section
8 Storage battery
9 Alternator
10 Transmission
100 Charging vehicle
110 Charging system
120 Cargo compartment
200 Electric vehicle
201 High-voltage battery
202 Power collection section
203 Charging port
204 Charging port
300 System power supply

1. A charging system, comprising:
a first power conversion section that has a rated output of 50 kW or less and that converts Alternating current (AC) supplied from an AC power source into Direct current (DC); and
a second power conversion section that includes a function to supply a storage battery with DC output from the first power conversion section and a function to generate DC power exceeding 50 kW, by using the DC output from the storage battery, and to supply an electric vehicle with the generated DC power through a contactor.

2. The charging system according to claim 1, wherein the first power conversion section is a charger having a rated output of 50 kW.

3. The charging system according to claim 1, wherein the first power conversion section is a charger conforming to a CHAdeMO system.

4. A charging vehicle comprising the charging system according to claim 1.
